(19) United States
(12) Patent Application Publication
(10) Pub. No.: US 2016/0122203 A1
(43) Pub. Date: May 5, 2016

(54) FLUID EVAPORATION APPARATUS INCLUDING FUEL CELLS

(71) Applicant: Faris Fayiz ALSHEHRI, Kent, OH (US)

(72) Inventor: Faris Fayiz ALSHEHRI, Kent, OH (US)

(21) Appl. No.: 14/531,611

(22) Filed: Nov. 3, 2014

(51) Int. Cl. C02F 1/04; C02F 1/00; H01M 8/10

(52) U.S. Cl. CPC C02F 1/048; H01M 8/1018; C02F 1/004; H01M 2250/10; H01M 2008/1095; C02F 2103/365

(57) ABSTRACT

A fluid evaporation apparatus utilizes a sustainable energy source via fuel cells to evaporate large quantities of water or liquid within a predetermined time frame. This water or liquid may be in difficult to reach locations and thus, the apparatus may be mobile and sized based on any required application large or small. The apparatus includes an electrochemical power source and a fluid evaporator electrically connected to the electrochemical power source. The apparatus also includes a fluid filter electrically connected to the electrochemical power source and a pump electrically connected to the electrochemical power source. The electrochemical power source, the fluid evaporator, the fluid filter, and the pump are fluidly connected to suction and evaporate a fluid source. The electrochemical power source, the fluid evaporator, the fluid filter, and the pump are electronically actuated by a controller.

### GRANT OF NON-EXCLUSIVE RIGHT

This application was prepared with financial support from the Saudia Arabian Cultural Mission, and in consideration therefore the present inventor(s) has granted. The Kingdom of Saudi Arabia a non-exclusive right to practice the present invention.

### BACKGROUND

1. Field of the Disclosure

This disclosure relates to fluid evaporation devices including fuel cells and more specifically to a device for increasing the evaporation of fluids contained in still or stagnant locations while using a sustainable power source.

2. Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

In instances both by nature and by man, water or other fluids may collect in large amounts in undesired locations, such as ponds, swamps, roadways, etc. For example, in most oil and gas drilling operations, drilling fluid or mud is used to remove drill cuttings from the borehole. The drilling fluid is usually a mixture of clays, chemicals, weighting material and water or oil. The drilling fluid generally is pumped from a mud pit to a standpipe, through a Kelly hose to a swivel, through the Kelly and down into the drill string to the bit. From there the fluid and cuttings flow back up the annular space around the drill string to a mud return line. From the return line the fluid passes across a shaker where the cuttings are removed and on to a reserve or pond. The pond is used to collect the excess water. Water production can continue throughout the life of the well.

The problem with this arrangement is that the collected water in the pond must be disposed of. Various evaporation systems have been devised to accomplish this task. Typically, these systems involve spraying the water into the air using high-pressure pumps and nozzle arrays that maximize the surface area of the water droplets in order to increase evaporation rates. Many of the evaporation systems are designed to evaporate the water while floating over the wastewater pond to minimize ground saturation.

These evaporation systems have several disadvantages. First, they cannot operate in high winds or extreme cold weather. Second, the mist still allows for ground saturation in areas of sustained winds which requires system shutdown. Third, these systems can be cumbersome to set up, maintain and move. Fourth, these evaporation systems are limited to impoundment pond operations. Once a drilling site has been reclaimed, the excess water ends up in a storage tank which current evaporation systems cannot access.

In another example, still or stagnant water, such as rain or storm water, swamp water or the like is historically difficult to eliminate or remove via evaporation. Still or stagnant water may further pose a risk to people and/or traffic flow of vehicles after a storm or weather event. Draining swamps and still or stagnant water may cause people to get injured, drown, or cause disease, such as malaria or hay fever.

As recognized by the present inventor, there is a need to develop an evaporation tool or apparatus which can quickly handle varying amounts of standing or stagnant water/fluid in an effective and efficient manner.

### SUMMARY

Embodiments include a fluid evaporation apparatus having an electrochemical power source. The apparatus includes a fluid evaporator electrically connected to the electrochemical power source. The apparatus also includes a fluid filter electrically connected to the electrochemical power source. The apparatus further includes a pump electrically connected to the electrochemical power source. The electrochemical power source, the fluid evaporator, the fluid filter, and the pump are fluidly connected to suction and evaporate a fluid source. The electrochemical power source, the fluid evaporator, the fluid filter, and the pump are electronically actuated by a controller.

Embodiments also include a method, comprising activating an electrochemical power source to generate electricity. The method also includes converting the generated electricity to heat energy via a heating element within a fluid evaporator. The method further includes setting the fluid evaporator to a temperature of above 100° C. to evaporate a given fluid from a fluid source. The method also includes activating a pump to receive fluid or water from the fluid source. The method further includes transferring the fluid or water to a fluid filter via the pump. The method also includes transferring the fluid or water from the fluid filter to the fluid evaporator. The method further includes evaporating the fluid or water within the evaporator via the heating element as steam exhaust. The method also includes controlling the electrochemical power source, the fluid evaporator, the fluid filter, and the pump electronically via a controller.

Embodiments further include an apparatus having means for activating an electrochemical power source to generate electricity. The apparatus includes means for converting the generated electricity to heat energy via a heating element within a fluid evaporator. The apparatus also includes means for setting the fluid evaporator to a temperature of above 100° C. to evaporate a given fluid from a fluid source. The apparatus further includes means for activating a pump to receive fluid or water from the fluid source. The apparatus also includes means for transferring the fluid or water to a fluid filter via the pump. The apparatus further includes means for transferring the fluid or water from the fluid filter to the fluid evaporator. The apparatus also includes means for transferring a water output from the electrochemical power source to the fluid evaporator. The apparatus further includes means for evaporating the fluid or water within the fluid evaporator via the heating element as steam exhaust. The apparatus also includes means for controlling the electrochemical power source, the fluid evaporator, the fluid filter, and the pump electronically.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is an illustrative view of a fluid evaporation apparatus according to certain embodiments of the disclosure.

FIG. 2 is a flowchart of a method of evaporating water or liquids using the apparatus of FIG. 1 according to certain embodiments of the disclosure.

FIG. 3 is a block diagram of a fuel cell for the fluid evaporation apparatus of FIG. 1 according to certain embodiments of the disclosure.

FIG. 4 is a block diagram of a mobile fluid evaporation apparatus according to certain embodiments of the disclosure.

FIG. 5 is a block diagram of a boiler system for the fluid evaporation apparatus of FIG. 4 according to certain embodiments of the disclosure.

FIG. 6 is a block diagram of a fuel cell system for the fluid evaporation apparatus of FIG. 4 according to certain embodiments of the disclosure.

### DETAILED DESCRIPTION OF THE EMBODIMENTS

Referring now to the drawings, wherein like reference numerals designate identical or corresponding parts throughout the several views, a fluid evaporator includes fuel cells that provide the benefits of using sustainable environmental energy, saving time and money, and supporting governments and organizations with environmental projects regarding still or stagnant liquid/water removal.

An additional benefit may be for the fluid evaporator to provide certain areas of the world lacking in proper rainwater drainage networks to have a device which can readily remove any still or stagnant fluids/liquid. Other applications of the device may include swimming pools, swamp drainage to reduce disease, or removing still or stagnant fluids/water from roadways which may affect traffic.

Fuel cells are electrochemical devices that convert a fuel's chemical energy directly to electrical energy with high efficiency, with no moving parts. A fuel cell can produce electricity continuously as long as fuel and air are supplied in a sustainable manner. In general, a fuel cell is a device that converts the chemical energy from a fuel, such as methanol, into electricity through a chemical reaction with oxygen or another oxidizing agent.

The fluid evaporator utilizes fuel cells to produce electricity and convert it into heat energy in order to evaporate large quantities of fluid/water in a swift manner.

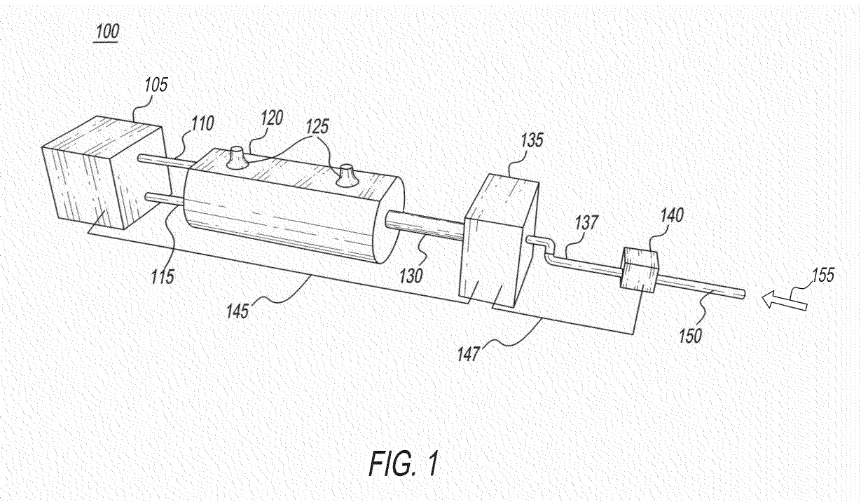

FIG. 1 is an illustrative view of a fluid evaporation apparatus 100 according to certain embodiments of the disclosure. In FIG. 1, the fluid evaporation apparatus 100 includes a fuel cell system 105, a first electric connector 110, a first fluid transfer pipe or boiler inlet 115, a boiler system 120 having exhaust pipes 125, a second fluid transfer pipe or filter outlet 130, a fluid filter 135, a third fluid transfer pipe or filter inlet 137, a pump 140, a second electric connector 145, a third electric connector 147, and a suction hose or pump inlet 150.

In some embodiments, the first electrical connector 110 is electrically connected to the fuel cell system 105 and transfers electricity from fuel cell system 105 to boiler system 120 to initiate the heating and subsequent evaporation of drawn in fluid/water from a fluid source 155, such as a swamp, pond or standing/stagnant fluid/water, via the suction hose 150 and pump 140 through the fluid filter 135 to the boiler system 120. Each of boiler system 120, filter 135, and pump 140 are configured to be electrically wired and powered by the fuel cell system 105. In certain embodiments, the boiler system 120 is configured to evaporate between 500 and 1,000 gallons of still or standing water within an hour.

In one embodiment, the fluid filter 135 is configured to prevent the passage of debris of a predetermined size to proceed to the boiler system 120. The predetermined size of debris may include grain sizes from about 50 to 150 micrometers (μm), particularly a grain size of about 100 μm. The fluid source 155 enters filter inlet 137 and flows into the fluid filter 135 that contains filtration media. There are multiple fluid paths within the filtration medium, along which the fluid source 155 can flow, thus becoming treated water. The treated water can leave the fluid filter 135 through the filter outlet 130.

The filtration media can contain carbonaceous media, such as activated carbon. There can be other components in the filtration media, such as carbonized synthetic materials, hydrophobic polymeric adsorbents, activated alumina, activated bauxite, fuller's earth, diatomaceous earth, silica gel, calcium sulfate, zeolite particles, inert particles, sand, surface charge-modified particles, metal oxides, metal hydroxides, or combinations thereof. All these media can be referred to as “active” media because they all interact with water to remove impurities therefrom.

Further, the pump 140 may be configured to suction at a predetermined rate, for example between 10 to 15 gallons per minute (GPM) to ensure fluid transfer and subsequent evaporation to a predetermined level, for example below 20% by volume of the fluid source 155 within a predetermined time frame, for example 24 to 48 hours.

In certain embodiments, the fuel cell system 105 may include a plurality of fuel cells configured to generate electricity to power the boiler system 120 via the first electric connector 110, and power the fluid filter 135 via the second electric connector 145, and power the pump 140 via the third electric connector 147. Also, the fuel cell system 105 is configured to expel water as a by-product of its chemical reaction and the fuel cell system 105 is configured to transfer this water via the first fluid transfer pipe 115 to the boiler system 120 for evaporation. Thus, the boiler system 120 is configured to receive water from fluid source 155 via second fluid transfer pipe 130 and from fuel cell system 105 via first fluid transfer pipe 115 for evaporation.

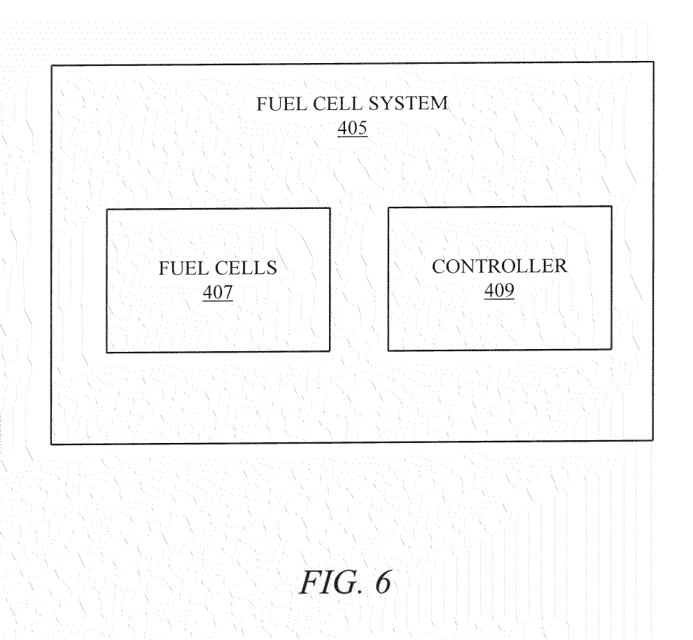

Further, the boiler system 120 may be configured via a controller (not shown) similarly configured as the controller 409 shown in FIG. 6 to automatically activate when the fuel cell system 105 is activated. Once the boiler system 120 reaches a predetermined temperature, such as 100° C. or higher, the pump 140 may be configured via the controller to also automatically activate and to begin pumping the water/fluid simultaneously to the boiler system 120 from the fluid source 155. When the boiler system 120 reaches its maximum capacity, the pump 140 may be configured to automatically deactivate via the controller, until a predetermined amount of fluid/water has evaporated from the boiler system 120. Upon evaporating an objective/predetermined quantity of fluid/water, the fuel cell system 105 is deactivated via the controller to cease the process.

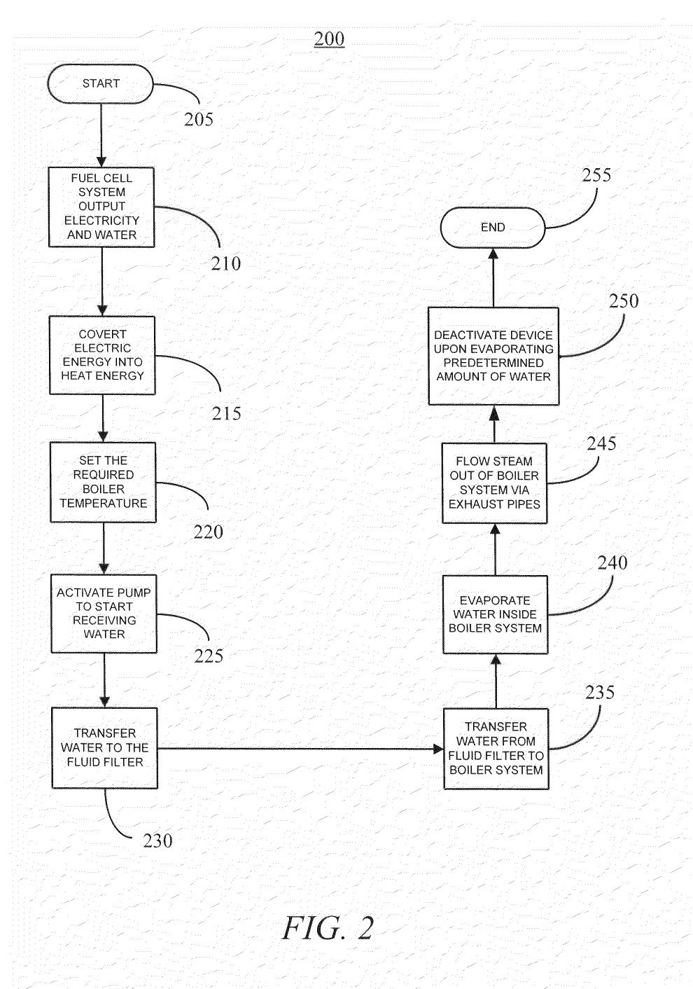

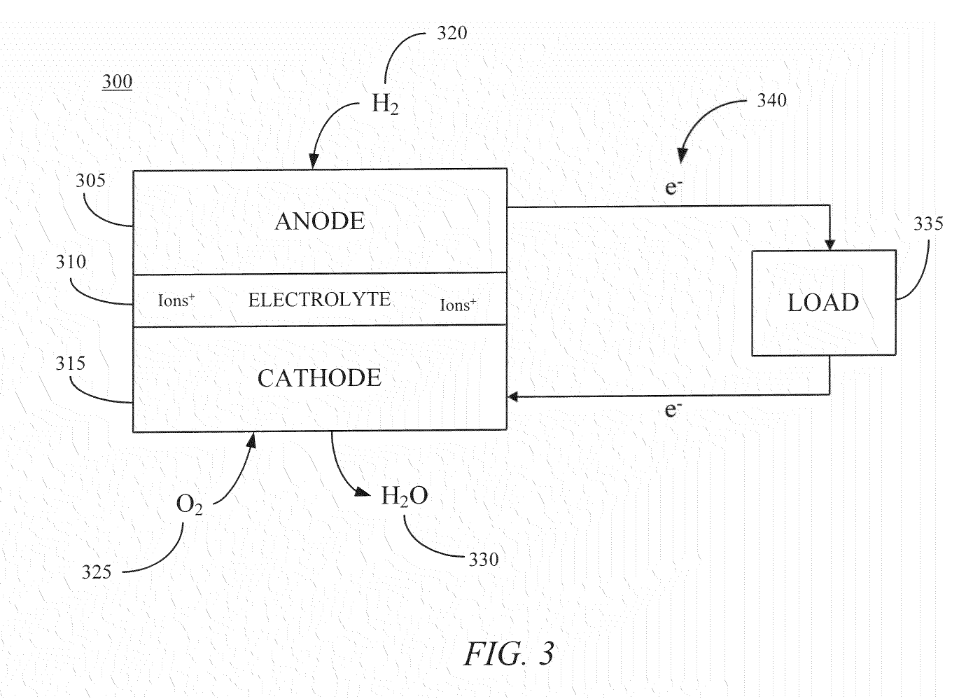

FIG. 2 is a flowchart of a method 200 of evaporating water or liquids using the device of FIG. 1 according to certain embodiments of the disclosure. In FIG. 2, at 205, the process is started by activating the fuel cell system 105. This step may be accomplished by supplying the fuel, such as hydrogen or methanol to the fuel cell in order to begin a chemical reaction to produce electricity (see FIG. 3).

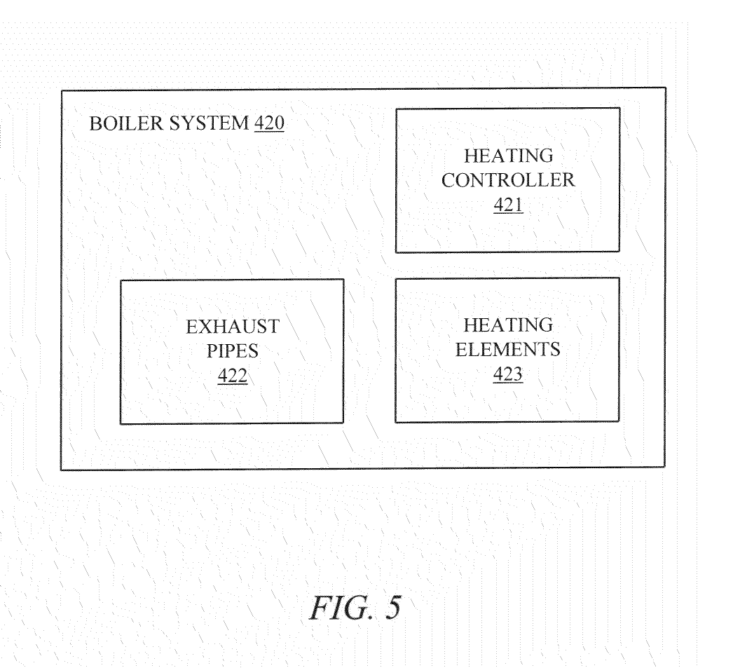

At 210, the fuel cell system 105 outputs electricity and water (H₂O) as shown in FIG. 3. At 215, the electricity is converted to heat energy via heating elements (see, for example, FIG. 5 at 423) within the boiler system 120.

At 220, a predetermined boiler temperature is set for the boiler system 120. At 225, the pump 140 is activated to receive fluid/water from the fluid source 155. Pump 140 is configured to operate at a predetermined rate to ensure a speedy removal of the fluid source 155, as needed.

At 230, fluid/water is transferred to the fluid filter 135 via pump 140. At 235, filtered fluid/water is transferred from the fluid filter 135 to the boiler system 120 for an evaporation process.

At 240, the fluid/water is evaporated inside the boiler system 120 heated by heating elements (see, for example, FIG. 5 at 423) powered by the fuel cell system 105. At 245, the evaporated fluid/water is expelled as steam from the exhaust pipes 125 of the boiler system 120.

At 250, the boiler system 120 is deactivated or shut down upon reaching a predetermined amount/level of evaporation of the fluid source 155, such as a swamp or any standing/stagnant water/fluid. At 255, the process is ended by deactivating the fuel cell system 105, thereby ceasing the generation of electricity to each of the pump 140, the fluid filter 135, and the boiler system 120.

FIG. 3 is a block diagram of a fuel cell system 300 for the fluid evaporator of FIG. 1 according to certain embodiments of the disclosure. In FIG. 3, the block diagram of the fuel cell system 300 includes an anode portion 305 and a cathode portion 315 with an electrolyte portion 310 sandwiched in-between. In one embodiment, the anode portion 305 receives hydrogen (H₂) fuel 320 and cathode portion 315 receives oxygen (O₂) at 325. The resulting output reaction is water (H₂O) at 330. The fuel cell system 300 also includes a load 335 electrically connected at 340 to the anode portion 305 and the cathode portion 315 to complete an electric circuit.

The anode portion 305 uses a catalyst to break down the fuel into electrons and ions. In some embodiments, the anode portion 305 is comprised of very fine platinum powder. The cathode portion 315 turns the ions into the waste chemicals, such as water or carbon dioxide (CO₂). In some embodiments, the cathode portion 315 is comprised of nickel or a nanomaterial-based catalyst.

The electrolyte portion 310 may define the type of fuel cell, for example, proton exchange membrane fuel cells (PEMFCs), phosphoric acid fuel cells (PAFCs), solid oxide fuel cells (SOFCs), molten carbonate fuel cells (MCFCs), or the like. The most common fuel used in a fuel cell is hydrogen.

PEMFCs, also known as polymer electrolyte membrane (PEM) fuel cells, are a type of fuel cell for transport applications as well as for stationary fuel cell applications and portable fuel cell applications. PEMFCs include features such as lower temperature/pressure ranges (50 to 100° C.) and a special polymer electrolyte membrane. The reaction in a PEM involves a proton exchange membrane fuel cell transforming the chemical energy liberated during the electrochemical reaction of hydrogen and oxygen to electrical energy. A stream of hydrogen is delivered to the anode side of the membrane electrode assembly (MEA). At the anode side it is catalytically split into protons and electrons. This oxidization half-cell reaction or Hydrogen Oxidation Reaction (HOR) is represented by:

At the anode:

H₂→2H⁺+2e⁻ (1)

at (1) the newly formed protons permeate through the polymer membrane to the cathode side. The electrons travel along an external load circuit to the cathode side of the MEA, thus creating the current output of the fuel cell. Meanwhile, at a stream of oxygen is delivered to the cathode side of the MEA. At (2) the cathode side, oxygen molecules react with the protons permeating through the polymer electrolyte membrane and the electrons arriving through the external circuit to form water molecules. This reduction half-cell reaction or oxygen reduction reaction (ORR) is represented by:

At the cathode:

½O₂+2H⁺+2e⁻→H₂O (2)

Overall reaction:

H₂+½O₂→H₂O (3)

The reversible reaction is shown in equation (3) and shows the reincorporation of hydrogen protons and electrons together with oxygen molecules resulting in the formation of one water molecule.

PAFCs are a type of fuel cell that uses liquid phosphoric acid as an electrolyte. PAFCs are designed to include an electrolyte having a high concentration or pure phosphoric acid (H₃PO₄) saturated in a silicon carbide matrix (SiC). PAFCs have an operating range of about 150 to 210° C. The electrodes in PAFCs are made of carbon paper coated with a finely dispersed platinum catalyst.

SOFCs are electrochemical conversion devices that produce electricity directly from oxidizing a fuel. SOFCs include a solid oxide or ceramic electrolyte. SOFCs operate at a very high temperature, typically between 500 and 1000° C. SOFCs may be configured to generate power outputs from 100 W to 2 MW.

MCFCs are high-temperature fuel cells that operate at temperatures of 600° C. and above. MCFCs use an electrolyte composed of a molten carbonate salt mixture suspended in a porous, chemically inert ceramic matrix of beta-alumina solid electrolyte (BASE). Since MCFCs operate at extremely high temperatures of 650° C. (roughly 1200° F.) and above, non-precious metals can be used as catalysts at the anode and cathode, reducing costs.

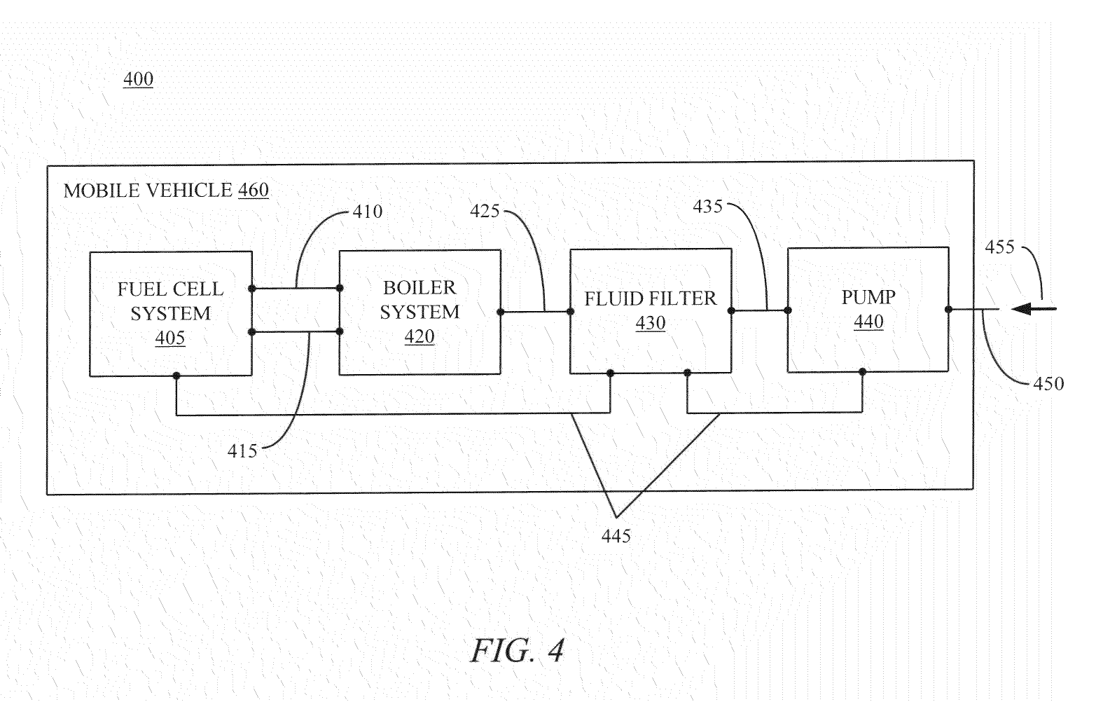

The type and size of fuel cell used may be dependent upon the power requirements to suction and evaporate a given sized fluid source 155 and whether the fluid evaporation apparatus 100 is configured to be stationary or mobile. For example, as stated above PEMFCs may be used in portable/mobile applications such as discussed below in FIG. 4.

FIG. 4 is a block diagram of a mobile fluid evaporation apparatus 400 according to certain embodiments of the disclosure. In FIG. 4, the mobile fluid evaporation apparatus 400 includes a fuel cell system 405, a first electric connector 410, a first fluid transfer pipe 415, a boiler system 420 including exhaust pipes 422, a second fluid transfer pipe or filter outlet 425, a fluid filter 430, a third fluid transfer pipe or filter inlet 435, a pump 440, a second electric connector 445, a suction hose 450, and a mobile vehicle 460.

In another embodiment, the mobile fluid evaporation apparatus 400 may be configured to operate in a mobile capacity via a mobile vehicle 460 to reach and to be transported to remote sites, as needed while carrying the mobile fluid evaporation apparatus 400. Also, the mobile fluid evaporation apparatus 400 may be configured to be sized based on the size of a fluid source 455 to be evaporated or removed at a specific location, such as a traffic area, swamp area, or the like.

In some embodiments, the first electric connector 410 is electrically connected to the fuel cell system 405 and transfers electricity from fuel cell system 405 to boiler system 420 to initiate the heating and subsequent evaporation of drawn in fluid/water from a fluid source 455, such as a swamp, pond or standing/stagnant fluid/water, via the suction hose 450 and pump 440 through the fluid filter 430 to the boiler system 420. Each of boiler system 120, fluid filter 430 and pump 440 are configured to be electrically connected and powered by the fuel cell system 405.

In one embodiment, the fluid filter 430 is configured to prevent the passage of debris of a predetermined size to proceed to the boiler system 420. The predetermined size of debris may include grain sizes from about 50 to 150 micrometers (μm), particularly a grain size of about 100 μm. The fluid source 455 enters filter inlet 435 and flows into the fluid filter 430 that contains filtration media. There are multiple fluid paths within the filtration medium, along which the fluid source 455 can flow, thus becoming treated water. The treated water can leave the fluid filter 430 through the filter outlet 425.

The filtration media can contain carbonaceous media, such as activated carbon. There can be other components in the filtration media, such as carbonized synthetic materials, hydrophobic polymeric adsorbents, activated alumina, activated bauxite, fuller's earth, diatomaceous earth, silica gel, calcium sulfate, zeolite particles, inert particles, sand, surface charge-modified particles, metal oxides, metal hydroxides, or combinations thereof. All these media can be referred to as “active” media because they all interact with water to remove impurities therefrom.

Further, the pump 440 may be configured to suction at a predetermined rate, for example between 15 to 35 gallons per minute (GPM) to ensure fluid transfer and subsequent evaporation to a predetermined level, for example below 20% by volume of the fluid source 455 within a predetermined time frame, for example 24 to 48 hours.

In certain embodiments, the fuel cell system 405 is configured to generate electricity to power the boiler system 420 via the first electric connector 410, and to power the fluid filter 430 and the pump 440 via the second electric connector 445. Also, the fuel cell system 405 is configured to expel water as a by-product of its chemical reaction and the fuel cell system 405 is configured to transfer this water via the first fluid transfer pipe 415 to the boiler system 420 for evaporation.

In some embodiments, the mobile vehicle 460 may be configured to support and/or hold the fuel cell system 405, the boiler system 420, the filter 430 and the pump 440 as well as their connections in a compact or condensed manner to allow for easy transport and mobility via a wheeled transport or the like. Mobile vehicle 460 may be sized to provide the transport of the mobile fluid evaporation apparatus 400 to any worksite in need of fluid/water evaporation for traffic safety, reduction in the spread of disease, or the like. For instance, the mobile vehicle 460 may include a flatbed truck, railway train, armored transport, or the like. Thus, the fluid evaporation apparatus 400 is sized dimensionally to fit on such mobile vehicles. For example, the fluid evaporation apparatus 400 may be sized at about 2 meters (m) in width and at about 7 m in length when disposed on a flatbed truck.

Alternatively, the mobile fluid evaporation apparatus 400 may be configured to additionally power the mobile vehicle 460 via an electrical power connection (not shown) from the fuel cell system 405.

Further, the mobile fluid evaporation apparatus 400 may have industrial and/or military applications. For example, in the drilling and oil industry the mobile fluid evaporation apparatus 400 may be utilized to remove fluids/water from mud pits near drilling sites in an efficient and fast manner. Also, in military theaters, the mobile fluid evaporation apparatus 400 may be utilized to remove standing water/fluids from roadways or traffic areas to maintain the flow of military convoys and the like.

Alternatively, the fluid evaporation apparatus 100, 400 may include a plurality of fuel cells, boiler systems, filters, and/or pumps, depending on the requirements for fluid/water evaporation of different sized fluid sources.

FIG. 5 is a block diagram of the boiler system 420 for the fluid evaporation apparatus 400 of FIG. 4 according to certain embodiments of the disclosure. In FIG. 5, the boiler system 420 includes a heating controller 421, exhaust pipes 422, and heating elements 423. The heating controller 421 may be configured to set and control the required evaporation temperature, such as 100° C., within the boiler system 420 based on the type and amount of fluid/water at the fluid source 455 to be evaporated. The heating controller 421 includes electronic circuitry (not shown) and is configured to electronically control the heating elements 423. Further, the heating controller 421 may be configured to supply electrical power to the heating elements 423. The heating controller 421 may be further configured to activate and deactivate the boiler system 420 based on certain criteria such as the level of depletion of the fluid source 455. This activation and deactivation may be configured to operate automatically based on detecting the depletion of the fluid source 455 via a sensor array (not shown). The exhaust pipes 422 are configured to expel the evaporated fluid/water as steam from the boiler system 420.

FIG. 6 is a block diagram of the fuel cell system 405 for the fluid evaporation apparatus 400 of FIG. 4 according to certain embodiments of the disclosure. In FIG. 6, the boiler system 420 may be configured via a controller 409 configured to automatically activate when the fuel cell system 405 is activated. Once the boiler system 420 reaches a predetermined temperature, such as 100° C. or higher, the pump 440 and fluid filter 430 may be configured via the controller 409 to also automatically activate and to begin pumping and filtering the water/fluid simultaneously to the boiler system 420 from the fluid source 455 via the fluid filter 430. When the boiler system 420 reaches its maximum capacity, for example 10,000 gallons, the pump 440 may be configured to automatically deactivate via the controller 409, until a predetermined amount of fluid/water, for example 5,000 gallons has evaporated from the boiler system 420. Upon evaporating an objective/predetermined quantity of fluid/water, the fuel cell system 405 is deactivated via the controller 409 to cease the process.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

1. A fluid evaporation apparatus, comprising:
an electrochemical power source;
a fluid evaporator electrically connected to the electrochemical power source;
a fluid filter electrically connected to the electrochemical power source; and
a pump electrically connected to the electrochemical power source,
wherein the electrochemical power source, the fluid evaporator, the fluid filter, and the pump are fluidly connected to suction and evaporate a fluid source, and
wherein the electrochemical power source, the fluid evaporator, the fluid filter, and the pump are electronically actuated by a controller.

2. The fluid evaporation apparatus according to claim 1, wherein electrochemical power source includes a fuel cell, wherein the fuel cell is configured to receive as input hydrogen (H₂) and oxygen (O₂) and produce as output of a self-contained chemical reaction electricity and water.

3. The fluid evaporation apparatus according to claim 2, wherein the water output from the fuel cell is recirculated to the fluid evaporator where the water is evaporated.

4. The fluid evaporation apparatus according to claim 1, wherein the fluid evaporator includes a boiler system having exhaust pipes, at least two fluid inlets, one of which being fluidly connected to the electrochemical power source and the other of the at least two fluid inlets being fluidly connected to the fluid filter, and the fluid evaporator having at least one heating element disposed therein electrically connected to the electrochemical power source.

5. The fluid evaporation apparatus according to claim 1, further comprising a mobile transport configured to carry and transport the electrochemical power source, the fluid evaporator, the fluid filter, and the pump to a location of the fluid source.

6. The fluid evaporation apparatus according to claim 1, wherein the electrochemical power source is configured to continuously produce electricity via a chemical reaction with oxygen or another oxidizing agent.

7. The fluid evaporation apparatus according to claim 1, wherein the evaporator is configured to evaporate at least 500 gallons of still or standing water within an hour.

8. The fluid evaporation apparatus according to claim 1, wherein the electrochemical power source includes polymer electrolyte membrane fuel cells (PEMFCs).

9. The fluid evaporation apparatus according to claim 1, wherein the fluid filter is configured to filter out debris sized between 50 and 150 micrometers in grain size.

10. The fluid evaporation apparatus according to claim 1, wherein the pump is configured to operate at a rate of 15 to 35 gallons per minute (GPM) to deplete the fluid source to a level of below 20% by volume within a time frame of 24 to 48 hours.

11. The fluid evaporation apparatus according to claim 1, wherein the fluid evaporator is powered by the electricity provided via an electric connector to the electrochemical power source, and
wherein the fluid filter and the pump are powered by electricity provided via a second and third electric connector, respectively, to the electrochemical power source.

12. A method, comprising:
activating an electrochemical power source to generate electricity;
converting the generated electricity to heat energy via a heating element within a fluid evaporator;
setting the fluid evaporator to a temperature of above 100° C. to evaporate a given fluid from a fluid source;
activating a pump to receive fluid or water from the fluid source;
transferring the fluid or water to a fluid filter via the pump;
transferring the fluid or water from the fluid filter to the fluid evaporator;
evaporating the fluid or water within the evaporator via the heating element as steam exhaust; and
controlling the electrochemical power source, the fluid evaporator, the fluid filter, and the pump electronically via a controller.

13. The method according to claim 12, wherein the pump is configured to operate at a rate of 15 to 35 GPM to deplete the fluid source to a level of below 20% by volume within a time frame of 24 to 48 hours.

14. The method according to claim 12, wherein the fluid evaporator is configured to deactivate upon reaching a depletion level of the fluid source of below 20% by volume.

15. The method according to claim 12, wherein the electrochemical power source includes a fuel cell, wherein the fuel cell is configured to receive as input hydrogen (H₂) and oxygen (O₂) and produce as output of a self-contained chemical reaction is electricity and water.

16. The method according to claim 12, wherein the fluid evaporator includes a boiler system having exhaust pipes, at least two fluid inlets, one of which being fluidly connected to the electrochemical power source and the other of the at least two fluid inlets being fluidly connected to the fluid filter, and the fluid evaporator having at least one heating element disposed therein electrically connected to the electrochemical power source.

17. The method of claim 12, further comprising:
transporting the electrochemical power source, the fluid evaporator, the fluid filter and the pump to the location of the fluid source.

18. The method of claim 12, wherein the fluid evaporator is powered by the electricity provided via an electric connector to the electrochemical power source, and
wherein the fluid filter and the pump are powered by electricity provided via a second and third electric connector, respectively, to the electrochemical power source.

19. The method of claim 12, wherein the electrochemical power source includes polymer electrolyte membrane fuel cells (PEMFCs).

20. An apparatus, comprising:
means for activating an electrochemical power source to generate electricity;
means for converting the generated electricity to heat energy via a heating element within a fluid evaporator;
means for setting the fluid evaporator to a temperature of above 100° C. to evaporate a given fluid from a fluid source;
means for activating a pump to receive fluid or water from the fluid source;
means for transferring the fluid or water to a fluid filter via the pump;
means for transferring the fluid or water from the fluid filter to the fluid evaporator;
means for transferring a water output from the electrochemical power source to the fluid evaporator;
means for evaporating the fluid or water within the fluid evaporator via the heating element as steam exhaust; and
means for controlling the electrochemical power source, the fluid evaporator, the fluid filter, and the pump electronically.
